(19) United States
(12) Patent Application Publication
(10) Pub. No.: US 2020/0355510 A1
(43) Pub. Date: Nov. 12, 2020

(54) METHOD AND SYSTEM FOR MULTI-MODAL TRANSPORTATION

(71) Applicant: DiDi Research America, LLC, Mountain View, CA (US)

(72) Inventors: Bo TAN, Sunnyvale, CA (US); Shanxiang QI, Burlingame, CA (US); Bin PAN, San Mateo, CA (US)

(21) Appl. No.: 16/408,654

(22) Filed: May 10, 2019

(51) Int. Cl. G01C 21/34; G06Q 10/02; G06Q 50/30

(52) U.S. Cl. CPC G01C 21/3423; G01C 21/343; G06Q 50/30; G06Q 10/025; G01C 21/3438

(57) ABSTRACT

Multi-modal itineraries may be scheduled by setting a time to request a future transportation mode. An itinerary including a set of transportation modes to allow a rider to travel from an origin to a destination may be obtained. A first non-self-controlled transportation mode from the set of transportation modes may be obtained. A second non-self-controlled transportation mode from the set of transportation modes may be obtained. A request time for the second non-self-controlled transportation mode may be scheduled.

### TECHNICAL FIELD

The disclosure relates generally to scheduling itineraries including multiple modes of transportation.

### BACKGROUND

Ride sharing platforms may match drivers of personal cars or taxis with riders to provide on-demand transportation services. Two common goals of ride sharing platforms are to improve user experience and increase user engagement. The user experience may be improved and the user engagement may be increased by scheduling itineraries including multiple modes of transportation.

### SUMMARY

One aspect of the present disclosure is directed to a system for scheduling multi-modal itineraries. The system may comprise one or more processors and one or more non-transitory computer-readable memories coupled to the one or more processors and configured with instructions executable by the one or more processors. Executing the instructions may cause the system to perform operations comprising: obtaining an itinerary including a set of transportation modes to allow a rider to travel from an origin to a destination; obtaining a first non-self-controlled transportation mode from the set of transportation modes; obtaining a second non-self-controlled transportation mode from the set of transportation modes; and scheduling a request time for the second non-self-controlled transportation mode.

Another aspect of the present disclosure is directed to a method for scheduling multi-modal itineraries, comprising: obtaining an itinerary including a set of transportation modes to allow a rider to travel from an origin to a destination; obtaining a first non-self-controlled transportation mode from the set of transportation modes; obtaining a second non-self-controlled transportation mode from the set of transportation modes; and scheduling a request time for the second non-self-controlled transportation mode.

Yet another aspect of the present disclosure is directed to a non-transitory computer-readable storage medium configured with instructions executable by one or more processors to cause the one or more processors to perform operations comprising: obtaining an itinerary including a set of transportation modes to allow a rider to travel from an origin to a destination; obtaining a first non-self-controlled transportation mode from the set of transportation modes; obtaining a second non-self-controlled transportation mode from the set of transportation modes; and scheduling a request time for the second non-self-controlled transportation mode.

In some embodiments, the itinerary may be obtained based on a selection by the rider.

In some embodiments, the first non-self-controlled mode may include public transportation.

In some embodiments, the second non-self-controlled mode may include ride sharing.

In some embodiments, the request time for the ride sharing may be scheduled for during the first non-self-controlled mode.

In some embodiments, a start time of the second non-self-controlled transportation mode may be obtained; and the request time may be scheduled for before the start time.

In some embodiments, a delay during the first non-self-controlled transportation mode may be determined. The delay may cause the rider to miss a start time of the second non-self-controlled transportation mode. A set of tail itineraries may be generated. Each itinerary in the set of tail itineraries may include a set of transportation modes to allow the rider to travel from a current location to the destination.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 illustrates an example environment for scheduling multi-modal itineraries, in accordance with various embodiments of the disclosure.

FIG. 2 illustrates a flowchart of an example process for scheduling future requests, in accordance with various embodiments of the disclosure.

FIG. 3 illustrates an example set of itineraries, in accordance with various embodiments of the disclosure.

FIG. 4 illustrates a flowchart of an example method for scheduling multi-modal itineraries, according to various embodiments of the present disclosure.

FIG. 5 is a block diagram that illustrates a computer system upon which any of the embodiments described herein may be implemented.

### DETAILED DESCRIPTION OF THE EMBODIMENTS

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

The approaches disclosed herein may improve a user experience and increase user engagement by scheduling itineraries including multiple modes of transportation. Rider sharing platforms match riders with drivers to provide transportation services. A rider may also be matched with co-riders who travel along similar routes to create a carpool. Riders may be required to walk to pick-up locations or from drop-off locations. A ride sharing platform may plan trip itineraries with multiple transportation modes. This allows each rider to choose the most suitable itinerary based on the context and other factors he/she cares about. Real-world matching, scheduling and transporting may be executed. Transportation modes may include solo and carpool ride sharing modes, as well as public transits, bicycles, scooters, self-driving cars, flights, and boats. As a result, the flexibility of choices for riders based on their preferences in terms of many factors may be largely expanded. The user experience for the riders may improve, and the goal of increased user engagement may be achieved. Additionally, by introducing many cheaper options, more price-sensitive new users may be attracted to the platform, contributing to user and revenue growth.

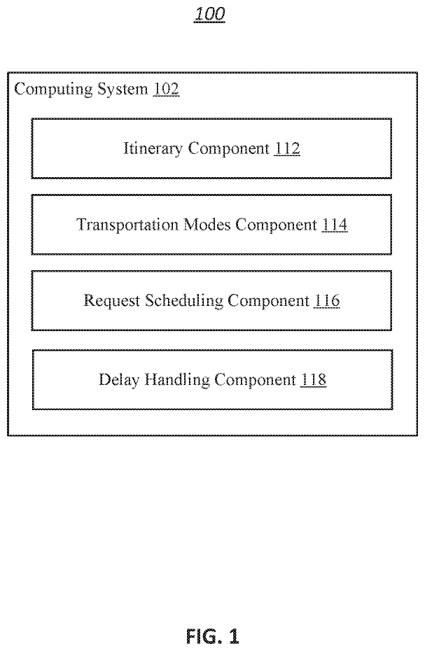

FIG. 1 illustrates an example environment 100 for scheduling multi-modal itineraries, in accordance with various embodiments. The example environment 100 may include a computing system 102. The computing system 102 may include one or more processors (e.g., a digital processor, an analog processor, a digital circuit designed to process information, a central processing unit, a graphics processing unit, a microcontroller or microprocessor, an analog circuit designed to process information, a state machine, and/or other mechanisms for electronically processing information) and memory (e.g., permanent memory, temporary memory). The processor(s) may be configured to perform various operations by interpreting machine-readable instructions stored in the memory. The computing system 102 may include other computing resources. In some implementations, computing system 102 may comprise a single self-contained hardware device configured to be communicatively coupled or physically attached to a component of a computer system. In some implementations, computing system 102 may include an application specific integrated circuit (ASIC) or a field-programmable gate array (FPGA) configured to perform transaction verification operations associated with one or more decentralized applications.

The computing system 102 may include an itinerary component 112, a transportation modes component 114, and a request scheduling component 116. In some embodiments the computing system 102, may further include a delay handling component 118. The computing system 102 may include other components. While the computing system 102 is shown in FIG. 1 as a single entity, this is merely for ease of reference and is not meant to be limiting. One or more components or one or more functionalities of the computing system 102 described herein may be implemented in a single computing device or multiple computing devices. In some embodiments, one or more components or one or more functionalities of the computing system 102 described herein may be implemented in one or more networks (e.g., enterprise networks), one or more endpoints, one or more servers, or one or more clouds. A server may include hardware or software which manages access to a centralized resource or service in a network. A cloud may include a cluster of servers and other devices which are distributed across a network. The computing system 102 may be implemented on or as various devices such as mobile phone, tablet, server, computer, wearable device (smart watch), etc. The system 102 above may be installed with appropriate software (e.g., platform program, etc.) and/or hardware (e.g., wires, wireless connections, etc.) to access other devices of the environment 100.

The itinerary component 112 may be configured to obtain an itinerary. The itinerary may include a set of transportation modes to allow a rider to travel from an origin to a destination. The origin, destination, and other location information may comprise GPS (Global Positioning System) coordinates. In some embodiments, the origin and destination may be entered by the rider. In some embodiments, the origin may be determined using the location of the rider's device (e.g. using GPS or access points connected to the rider's device). The itinerary component 112 may obtain itineraries from one or more locations. For example, the itinerary component 112 may obtain itineraries from a storage location, such as an electronic storage of the computing system 102, an electronic storage of a device accessible via a network (e.g., server), one of more client devices (e.g., desktop, laptop, smartphone, tablet, mobile device), or other locations. Obtaining information may include one or more of accessing, acquiring, analyzing, determining, examining, identifying, loading, locating, opening, receiving, retrieving, reviewing, storing, or otherwise obtaining the information.

In some embodiments, an itinerary may be obtained based on a selection by a rider. For example, a list of itineraries may be displayed, and the rider may select an itinerary from the list. A list of itineraries may be obtained from one or more locations. The list of itineraries may be displayed in response to rider context information. For example, a list of itineraries may be recommended based on the rider context information. Rider context information may include any information which may be used to determine the preferences of the rider. For example, rider context information may include background information about a rider, information about past rider behaviors, information entered by the rider, and information based on where the rider is located. Rider context information may be stored in association with a personal profile of the rider. A rider profile may include user preferences selected by a rider.

In some embodiments, the rider context information may include demographic information and environmental data. For example, demographic information may include age, gender, education level, income level, marital status, occupation, religion, how many trips a rider makes a week, and how long the rider has used the multimodal transportation platform for. Environmental data may include weather, ruggedness of the terrain, time of day (e.g. day or night), and safety properties of the origin and destination. In some embodiments, environmental data may include inconvenience in certain transportation modes. For example, inconvenience may include walking distance and potential detour time (e.g. for carpooling).

In some embodiments, the rider context information may include timing information indicating a time for a future trip time. The future trip time may be for later in a same day, or for another day. The time for a future trip time may be an arrival time or a departure time. For example, using either an arrival or departure time, the rider can search for evening commute itineraries in the morning. In some embodiments, the future trip time may be entered by the rider. In some embodiment, the rider context information may include timing information indicating that the rider desires to depart as soon as possible. For example, if the rider does not enter a departure time, the multimodal transportation platform may default to scheduling a ride instantly.

The transportation modes component 114 may be configured to obtain modes of transportation included in itineraries. Modes of transportation may be obtained from an itinerary selected by a rider. Modes of transportation may include self-controlled transportation modes and non-self-controlled transportation modes. Self-controlled transportation modes may include walking, biking, and scooting. For example, bikes or scooters may be part of a bike or scooter sharing program. Non-self-controlled transportation modes may include ride sharing and public transportation. Ride sharing may include a solo or carpool (i.e. multiple riders) service. Ride sharing may use vehicles with human drivers or self-driving vehicles. Public transportation may include heavy rail services (e.g. Amtrak), light rail services—(e.g. metro, subway), buses, trolleys, ferries, and airplanes.

The transportation modes component 114 may obtain a first and a second non-self-controlled transportation mode from a set of transportation modes. In some embodiments, the first non-self-controlled mode may include public transportation. In some embodiments, the second non-self-controlled mode includes ride sharing. In some embodiments, modes of transportation may be owned by the provider of the multimodal transportation platform. In some embodiments, modes of transportation may be owned by third party vendors. In some embodiments, the multimodal transportation platform may communicate with the third party vendors through Application Programing Interfaces (APIs). For example, the multimodal transportation platform may send a request for a transportation service through an API. In some embodiments, the multimodal transportation platform may craw websites for publicly accessible information of the third party vendor. In some embodiments, the third party vendor may be a government. For example, the multimodal transportation platform may craw a government website to monitor a train or bus schedule.

An itinerary may include multiple consecutive different modes of transportation. For example, an itinerary may include a public transportation mode followed by a ride sharing mode. A single transportation mode may be included two or more times in a single itinerary. For example, an itinerary may include multiple types of public transportation. The first transportation mode may start at the origin and the last transportation mode may end at the destination, so that together, all of the modes allow the rider to travel from the origin to the destination. Multi-modal transportation sequences may satisfy timing requirements. For example, certain time margins may be kept to make a smooth exchange between two adjacent transportation modes.

In some embodiments, environmental data may include supply and demand for the different modes of transportation. For example, the environmental data may include supply and demand at the time of the request. In some embodiments, environmental data may include pricing data. Pricing data may include different prices for the different modes of transportation. The pricing data may include the price for one of the modes of transportation, or the price for the entire trip. In some embodiment, the pricing data may be estimated. In some embodiments, the pricing data may include a platform-controlled part, plus standard third-party charges (e.g., public transit tickets). In some embodiments, the pricing data may include a bundle price for a multi-modal transportation service, controlled totally by the platform. For example, the estimated pricing data may be included in a monthly subscription to the multimodal transportation platform. In some embodiments, corresponding payments for third-party transportation modes may be integrated with the multimodal transportation platform. For example, the multimodal transportation platform may provide payment to the third-party transportation modes either before or after the multimodal transportation platform receives payment from the rider.

In some embodiments, filtering criteria selected by the rider may be use to generate a set of itineraries satisfying the filtering criteria. The filtering criteria may include avoiding certain transportation modes (e.g. buses, trains, carpooling), highways, and tolls. The filtering criteria may additionally include an upper limit of transportation mode exchanges, a maximum walking distance, a maximum cost, and a maximum travel time. Historical choices of the rider may be recorded. For example, the price, estimated duration, number of transportation modes, and types of transportation modes may be recorded as rider context information when a rider selects an itinerary.

The request scheduling component 116 may be configured to schedule a time (request time) for requesting the second non-self-controlled transportation mode. In some embodiments, a start time of the second non-self-controlled transportation mode may be obtained. The start time may be obtained when the transportation mode is obtained. The request time for the second non-self-controlled transportation mode may be scheduled for before the start time. The scheduled request time may be calculated by subtracting a wait time and an estimated time for pickup from the start time. A wait time may include a certain duration for which the matching algorithm takes to run. The wait time may be obtained when the transportation mode is obtained. The estimated time for pickup may include an estimate of how long it will take for a driver to arrive.

In some embodiments, a second non-self-controlled mode may include ride sharing. A request for ride sharing may include matching the rider with a driver. For example, the request may be an e-hailing for the ride sharing. In some embodiments, the scheduled time for requesting the ride sharing may be during the first non-self-controlled mode. In some embodiments, a first non-self-controlled mode may include public transportation. For example, a request for the ride sharing may be scheduled for while the rider is on the public transportation.

In some embodiments, request scheduling may be applied iteratively. When a current non-self-controlled transportation mode is completed, the next non-self-controlled mode may become the current mode. Multi-modal scheduling may be applied to a tail itinerary. The tail itinerary may include the transportation modes that have not been completed.

The delay handling component 118 may be configured to generate a new set of itineraries when it is determined that there is a delay during a current non-self-controlled transportation mode. While the current non-self-controlled transportation mode allows the rider to arrive at a current location, the delay may cause the rider to miss a start time of a second/subsequent non-self-controlled transportation mode. A delay may be determined by monitoring the progress of a current transportation mode. For example, a delay may be caused by traffic or a detour. In some embodiments, the second non-self-controlled transportation mode may include public transportation. Missing the start time may include missing the departure time of the public transportation.

In some embodiments, a set of tail itineraries may be generated. Each itinerary in the set of tail itineraries may include a set of transportation modes to allow the rider to travel from a current location to a destination. The set of tail itineraries may be generated based on the rider context information. Each itinerary in the set of tail itineraries may include at least one mode of transportation to allow the rider to travel from the current location to the destination. For example, a tail itinerary may include only a single mode of transportation to travel all the way from the current location to the destination. At least one tail itinerary in the set of one or more tail itineraries may include at least a first non-self-controlled transportation mode and a second non-self-controlled transportation mode. A tail itinerary may include multiple consecutive different modes of transportation. For example, a tail itinerary may include a public transportation mode followed by a ride sharing mode. A single transportation mode may be included two or more times in a single tail itinerary. For example, a tail itinerary may include multiple types of public transportation. The first transportation mode may start at the current location and the last transportation mode may end at the destination, so that together, all of the modes allow the rider to travel from the current location to the destination. Multi-modal transportation sequences may satisfy timing requirements. For example, certain time margins may be kept to make a smooth exchange between two adjacent transportation modes. Timing and pricing may be calculated for each itinerary.

In some embodiments, the set of itineraries or tail itineraries may be filtered to exclude itineraries that fail to include the filtering criteria. For example, itineraries or tail itineraries including ineligible modes of transportation may be excluded. For example, carpooling modes having two or more riders may be filtered out. The set of itineraries or tail itineraries may be limited to only itineraries including one transportation mode. For example, a set of itineraries or tail itineraries may be limited to one itinerary including public transportation, and another itinerary including ride sharing.

In some embodiments, each itinerary in the set of itineraries or tail itineraries may be ranked based on the rider context information. The ranking may be accomplished using machine learning. The machine learning models may be trained using rider context information. For example, data from the rider's profile and historical data on pricing, timing, walking distance, and weather may be used to train a model. In some embodiment, two-side marketplace balance (e.g. supply-demand) at the time of each historical request may be used to train a model. The ranking may be used to display highly ranked itineraries in highly visible locations.

In some embodiments, the delay handling component 118 may update the scheduled request time for a ride sharing mode. An estimated time for pickup may be updated based on delays. For example, the estimated time for pickup may be updated based on a delay for the driver. A ride sharing start time may be updated based on delays. For example, a ride sharing start time may be updated based on either delays for the rider or for the driver. The scheduled request time may be recalculated using an updated estimated time for pickup or an updated ride sharing start time.

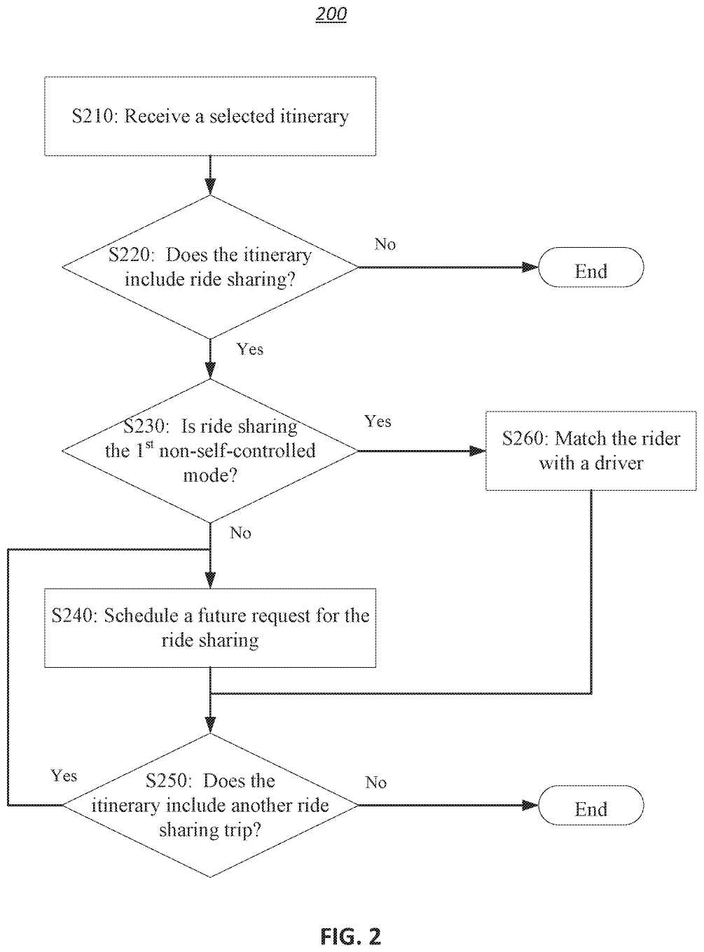

FIG. 2 illustrates a flowchart of an example process 200 for scheduling future requests, according to various embodiments of the present disclosure. The process 200 may be implemented in various environments including, for example, the environment 100 of FIG. 1. The operations of the process 200 presented below are intended to be illustrative. Depending on the implementation, the process 200 may include additional, fewer, or alternative operations performed in various orders or in parallel. The process 200 may be implemented in various computing systems or devices including one or more processors.

With respect to process 200, at step 210, an itinerary selected by a rider may be received. The selected itinerary may be used to request each service included in the itinerary. Each transportation mode in the selected itinerary may be monitored in real-time, and navigation functions may be provided to help the rider follow every step in the chosen itinerary. For self-controlled transportation modes (e.g. walking, biking, scooting), navigation functions may be displayed over a map in the application. For example, the locations of bikes may be displayed on the map. For non-self-controlled transportation modes, functions may include monitoring early arrival or delays of public transit, accidents, traffics, as well as the trajectory of the vehicles that the rider takes. For example, early arrivals and delays may be monitored.

After a selected itinerary is received, at step 220, the process may determine whether the itinerary includes a ride sharing service. If there are not any ride sharing services included in the selected itinerary, the result of the determination at step 220 may be “No”, and the process may end. For example, an itinerary may not require for any future requests for ride sharing to be scheduled. If the process determines that the selected itinerary does include at least one ride sharing trip, the process may proceed to step 230.

At step 230, the process may determine whether the first non-self-controlled transportation mode in the itinerary is ride sharing. The first non-self-controlled transportation mode may not be the first transportation mode in the selected itinerary. For example, the first transportation mode may be a self-controlled transportation mode such as walking. If it is determined at step 230 that the first non-self-controlled transportation mode is not ride sharing, the process my proceed to step 240.

At step 240, a future request for the ride sharing may be scheduled. The scheduled time for the future request may be chosen as a function of the start time of the next ride sharing trip in the itinerary. For example, the first non-self-controlled transportation mode may be public transportation, and the ride sharing may be scheduled for after the public transportation. The scheduled time may be a set period of time before the end of the preceding transportation mode. The timing may be updated based on real-time monitoring of the progress of the current transportation mode. The multimodal transportation platform may predict delays and adjust the future scheduling accordingly. This may prevent the driver of the ride sharing vehicle from arriving too early or too late. For example, the platform may monitor traffic in real time, monitor the GPS location of the rider, and/or monitor the walking speed of the rider. The monitored data may be used to predict when each mode of transportation will be completed.

In some embodiments, an automatic future request may be scheduled without further interaction from the rider. For example, the multimodal transportation platform may schedule for a request for ride sharing to be sent automatically at the scheduled time. In some embodiments, the multimodal transportation platform may schedule a notification to prompt the rider to manually perform the request. For example, the platform may prompt the rider to call for a ride sharing car while the rider is on public transportation. As a result the ride sharing car may be ready to pick up the rider when the rider gets off the bus. After a future request for ride sharing has been scheduled, the process may proceed to step 250.

At step 250, the process may determine whether the itinerary includes another ride sharing trip. If the itinerary includes another ride sharing trip, the process may go back to step 240 to schedule a future request for the next ride sharing trip. This process results in a loop until all ride sharing trips have been scheduled. After all ride sharing trips have been scheduled, the result of the determination at step 250 may be “No”, and the process may end. In some embodiments, the future scheduling may be performed in real-time as the rider follows the itinerary. For example, after the rider reaches a next transportation mode, it may become the current transportation mode and the future scheduling may be apply iteratively.

If it is determined at step 230 that the first non-self-controlled transportation mode in the itinerary is ride sharing, the process may proceed to step 260. At step 260, the process may match the rider with a driver. The platform may look for a potential driver based on matching algorithms. A self-controlled transportation mode (e.g. walking, biking, scooting) may be utilized to get the rider to the pickup location for the ride sharing.

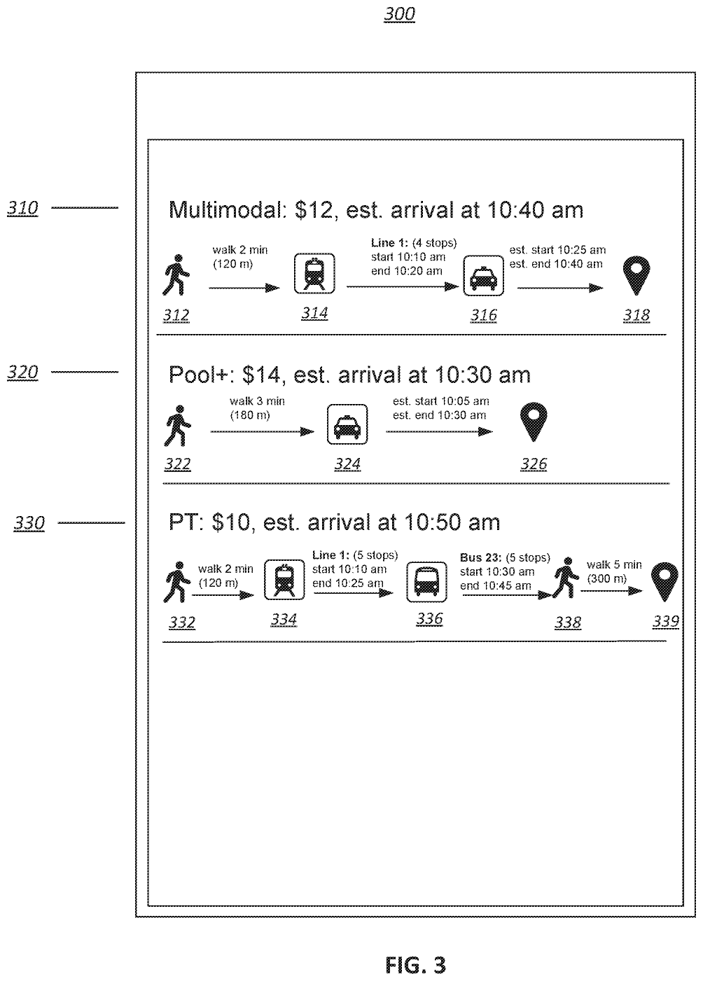

FIG. 3 illustrates an example set of itineraries 300, according to various embodiments of the present disclosure. The set of itineraries 300 may be stored on an electronic storage of the computing system 102, an electronic storage of a device accessible via a network (e.g., server), one of more client devices (e.g., desktop, laptop, smartphone, tablet, mobile device), or other locations. The set of itineraries 300 includes multimodal itinerary 310, pool+itinerary 320, and public transportation (PT) itinerary 330. The itineraries may include information to help a rider chose an itinerary. Multimodal itinerary 310 may include a price and an estimated arrival time. For example, the price may be $12 and the estimated arrival time may be 10:40 am. Multimodal itinerary 310 may include walking 312 as first transportation mode, public transportation 314 as a second transportation mode, a ride sharing service 316 as a third transportation mode, and a destination 318. The walking 312 may include a distance of 120 meters (m) and an estimated time of 2 minutes (min). The public transportation 314 may include an icon and a label indicating the type of public transportation, an indication of how many stops the transportation mode includes, a start time, and an end time. For example, the icon may be of a train, and the label may include “Line 1”, “4 stops”, “start 10:10 am”, and end “10:20 am”. The a ride sharing service 316 may include a label indicating an estimated start time and an estimated end time. For example, the label may include “est. start 10:25 am”, and est. end “10:40 am”.

Pool+itinerary 320 may include a price and an estimated arrival time. For example, the price may be $14 and the estimated arrival time may be 10:30 am. Pool+itinerary 320 may include walking 322 as first transportation mode, a ride sharing service 324 as a second transportation mode, and a destination 326. The walking 322 may include a distance of 180 m and an estimated time of 3 min. The a ride sharing service 324 may include a label indicating an estimated start time and an estimated end time. For example, the label may include “est. start 10:05 am”, and “est. end 10:30 am”.

Public transportation (PT) itinerary 330 may include a price and an estimated arrival time. For example, the price may be $10 and the estimated arrival time may be 10:50 am. PT itinerary 330 may include walking 332 as first transportation mode, public transportation 334 as a second transportation mode, a public transportation 336 as a third transportation mode, walking 338 as a fourth transportation mode and a destination 339. The walking 332 may include a distance of 120 m and an estimated time of 2 min. The public transportation 334 may include an icon and a label indicating the type of public transportation, an indication of how many stops the transportation mode includes, a start time, and an end time. For example, the icon may be of a train, and the label may include “Line 1”, “5 stops”, “start 10:10 am”, and “end 10:25 am”. The public transportation 336 may comprise a different type of public transportation than public transportation 334. The public transportation 336 may include an icon and a label indicating the type of public transportation, an indication of how many stops the transportation mode includes, a start time, and an end time. For example, the icon may be of a bus, and the label may include “Bus 23”, “5 stops”, “start 10:30 am”, and “end 10:45 am”. The walking 338 may include a distance of 300 m and an estimated time of 5 min.

In some embodiments, the set of itineraries 300 may be provided to a rider through an I/O interface. An I/O interface may comprise an auditory interface and a visual interface. For example, the set of itineraries 300 may be played as audio using a speaker. In another example, the set of itineraries 300 may be displayed on a Graphical User Interface (GUI). The GUI may be displayed on the screen of a user device. For example, the user device may be the same device on which computing system 102 is embodied.

In some embodiments, the itineraries in the set of itineraries 300 may be ranked. The itineraries may be ranked based on which route the user is most likely to choose. For example, the ranking algorithm may use the rider context information. The highest ranked itineraries may be displayed in the most visible location. As a result, the highest ranked itineraries may appear in the rider's eye first. In some embodiments, the highest ranked itineraries may be displayed at the top of the page. For example, the itinerary that ranks first may be displayed first, the itinerary that ranks second may be displayed second, and so on. In some embodiments, the highest ranked itineraries may be displayed in the middle of the page. In some embodiments, the rider may scroll the screen to view additional itineraries. For example the additional itineraries may have received lower recommendation scores. Additional itineraries may be viewed by scrolling down, to the right, left, or upward.

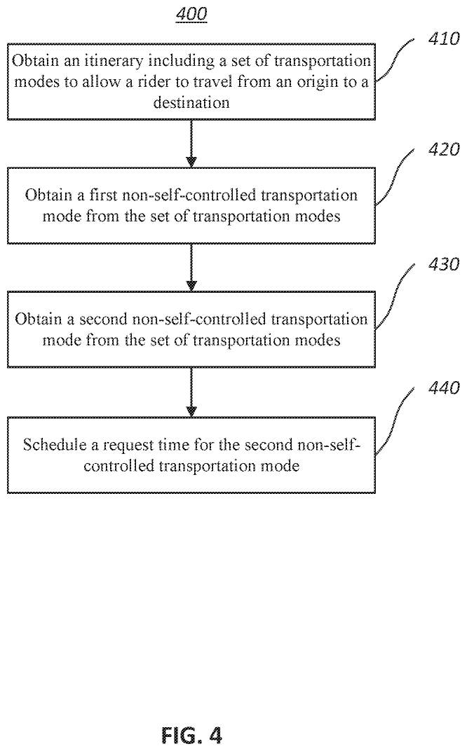

FIG. 4 illustrates a flowchart of an example method 400 for scheduling multi-modal itineraries, according to various embodiments of the present disclosure. The method 400 may be implemented in various environments including, for example, the environment 100 of FIG. 1. The operations of the method 400 presented below are intended to be illustrative. Depending on the implementation, the method 400 may include additional, fewer, or alternative steps performed in various orders or in parallel. The method 400 may be implemented in various computing systems or devices including one or more processors.

With respect to the method 400, at block 410, an itinerary including a set of transportation modes to allow a rider to travel from an origin to a destination may be obtained. At block 420, a first non-self-controlled transportation mode from the set of transportation modes may be obtained. At block 430, a second non-self-controlled transportation mode from the set of transportation modes may be obtained. At block 440, a request time for the second non-self-controlled transportation mode may be scheduled.

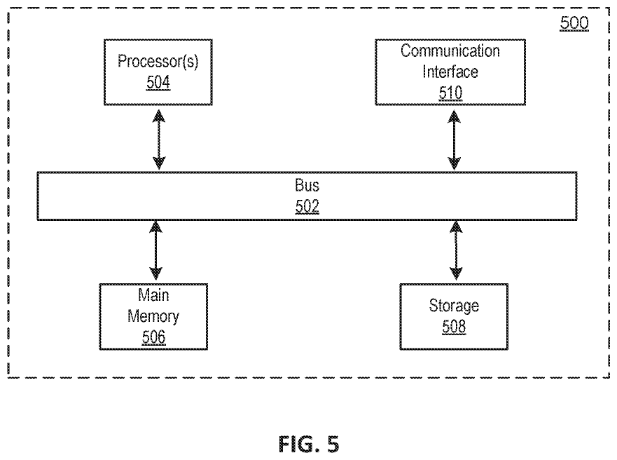

FIG. 5 is a block diagram that illustrates a computer system 500 upon which any of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor(s) 504. Main memory 506 also may be used for storing temporary variables or other intermediate information during execution of instructions to be executed by processor(s) 504. Such instructions, when stored in storage media accessible to processor(s) 504, render computer system 500 into a special-purpose machine that is customized to perform the operations specified in the instructions. Main memory 506 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 508. Execution of the sequences of instructions contained in main memory 506 causes processor(s) 504 to perform the process steps described herein.

For example, the computing system 500 may be used to implement the computing system 102 or one or more components of the computing system 102 shown in FIG. 1. As another example, the process/method shown in FIG. 4 and described in connection with this figure may be implemented by computer program instructions stored in main memory 506. When these instructions are executed by processor(s) 504, they may perform the steps as shown in FIG. 4 and described above. In alternative embodiments, hard-wired circuitry may be used in place of or in combination with software instructions.

The computer system 500 also includes a communication interface 510 coupled to bus 502. Communication interface 510 provides a two-way data communication coupling to one or more network links that are connected to one or more networks. As another example, communication interface 510 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner). As used herein, for convenience, components of the computing system 102 may be described as performing or configured for performing an operation, when the components may comprise instructions which may program or configure the computing system 102 to perform the operation.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A system for scheduling multi-modal itineraries, comprising one or more processors and one or more non-transitory computer-readable memories coupled to the one or more processors and configured with instructions executable by the one or more processors to cause the system to perform operations comprising:
obtaining an itinerary including a set of transportation modes to allow a rider to travel from an origin to a destination;
obtaining a first non-self-controlled transportation mode from the set of transportation modes;
obtaining a second non-self-controlled transportation mode from the set of transportation modes; and
scheduling a time for requesting the second non-self-controlled transportation mode.

2. The system of claim 1, wherein the itinerary is obtained based on a selection by the rider.

3. The system of claim 1, wherein the first non-self-controlled mode includes public transportation.

4. The system of claim 1, wherein the second non-self-controlled mode includes ride sharing.

5. The system of claim 4, wherein the time for requesting the ride sharing is during the first non-self-controlled mode.

6. The system of claim 1, the operations further comprising:
obtaining a start time of the second non-self-controlled transportation mode; and
scheduling the time for requesting the second non-self-controlled transportation mode before the start time.

7. The system of claim 1, the operations further comprising:
determining a delay during the first non-self-controlled transportation mode, wherein the delay causes the rider to miss a start time of the second non-self-controlled transportation mode; and
generating a set of tail itineraries, wherein each itinerary in the set of tail itineraries includes a set of transportation modes to allow the rider to travel from a current location to the destination.

8. A method for scheduling multi-modal itineraries, comprising:
obtaining an itinerary including a set of transportation modes to allow a rider to travel from an origin to a destination;
obtaining a first non-self-controlled transportation mode from the set of transportation modes;
obtaining a second non-self-controlled transportation mode from the set of transportation modes; and
scheduling a time for requesting the second non-self-controlled transportation mode.

9. The method of claim 8, wherein the itinerary is obtained based on a selection by the rider.

10. The method of claim 8, wherein the first non-self-controlled mode includes public transportation.

11. The method of claim 8, wherein the second non-self-controlled mode includes ride sharing.

12. The method of claim 11, wherein the time for requesting the ride sharing is during the first non-self-controlled mode.

13. The method of claim 8, further comprising:
obtaining a start time of the second non-self-controlled transportation mode; and
scheduling the time for requesting the second non-self-controlled transportation mode before the start time.

14. The method of claim 8, further comprising:
determining a delay during the first non-self-controlled transportation mode, wherein the delay causes the rider to miss a start time of the second non-self-controlled transportation mode; and
generating a set of tail itineraries, wherein each itinerary in the set of tail itineraries includes a set of transportation modes to allow the rider to travel from a current location to the destination.

15. A non-transitory computer-readable storage medium configured with instructions executable by one or more processors to cause the one or more processors to perform operations comprising:
obtaining an itinerary including a set of transportation modes to allow a rider to travel from an origin to a destination;
obtaining a first non-self-controlled transportation mode from the set of transportation modes;
obtaining a second non-self-controlled transportation mode from the set of transportation modes; and
scheduling a time for requesting the second non-self-controlled transportation mode.

16. The non-transitory computer-readable storage medium of claim 15, wherein the itinerary is obtained based on a selection by the rider.

17. The non-transitory computer-readable storage medium of claim 15, wherein the second non-self-controlled mode includes ride sharing.

18. The non-transitory computer-readable storage medium of claim 17, wherein the time for requesting the ride sharing is during the first non-self-controlled mode.

19. The non-transitory computer-readable storage medium of claim 15, the operations further comprising:
obtaining a start time of the second non-self-controlled transportation mode; and
scheduling the time for requesting the second non-self-controlled transportation mode before the start time

20. The non-transitory computer-readable storage medium of claim 15, the operations further comprising:
determining a delay during the first non-self-controlled transportation mode, wherein the delay causes the rider to miss a start time of the second non-self-controlled transportation mode; and
generating a set of tail itineraries, wherein each itinerary in the set of tail itineraries includes a set of transportation modes to allow the rider to travel from a current location to the destination.
